(19) United States
(12) Patent Application Publication
(10) Pub. No.: US 2010/0293243 A1
(43) Pub. Date: Nov. 18, 2010

(54) METHOD AND APPARATUS FOR MEASURING DIRECTIONALLY DIFFERENTIATED (ONE-WAY) NETWORK LATENCY

(75) Inventor: Tim Wittwer, Colorado Springs, CO (US)

Correspondence Address: PATENTTM.US, P. O. BOX 82788, PORTLAND, OR, 97282-0788, US

(73) Assignee: FLUKE CORPORATION, Everett, WA (US)

(21) Appl. No.: 12/466,309

(22) Filed: May 14, 2009

(51) Int. Cl. G06F 15/16

(52) U.S. Cl. 709/208

(57) ABSTRACT

Determining directionally differentiated latency in a network by use of master and slave test instruments to record latency measurements in their native time bases, and retrieving test instrument latency frame transmit/receive timestamps from the master and slave and converting them to the time base of one of the master or slave by use of the offset calculation, utilizing 3 bounce timestamp exchange, providing one-way latency measurement with resolution of less than 100 μs, using internal clocks in the test instruments, without requirement of expensive external time base technology.

### BACKGROUND OF THE INVENTION

This invention relates to networking test and measurement, and more particularly to network latency measurement.

Network latency is typically measured based on a round trip delay value, by dividing the round trip time of a test message by two. The latency is thus determined based on the time between sending a delay test request to another network station and the time when the reply back from the other station is received.

However, the delay component of network traffic may differ between upstream and downstream transmission, and such typical techniques provide no knowledge as to what portion of the delay is attributable to upstream and downstream traffic transmission. Without such knowledge, troubleshooting of network issues is less efficiently accomplished.

Prior solutions to the desire for determination of one-way latency require use of external time base technology, for example, under IEEE 1588 precision time protocol employing cesium clocks. Such solutions are expensive, limiting their availability.

Another mechanism involves remotely synchronizing the timing mechanism of multiple devices for one-way latency measurements by utilizing a global standard time via GPS to synchronize the timing clocks of the respective devices to a common real-world time. However, access to the sky and GPS satellites is problematic in many indoor lab environments, and the equipment is expensive.

### SUMMARY OF THE INVENTION

In accordance with the invention, a method and apparatus are provided combining hardware assisted network frame transmit/receive time stamping and master/slave device clock offset characterization to measure directionally differentiated network latency.

Accordingly, it is an object of the present invention to provide an improved network test system to determine directionally differentiated network latency.

It is a further object of the present invention to provide an improved method of determining directionally differentiated network latency.

It is yet another object of the present invention to provide an improved test and measurement system for determining directionally differentiated network latency.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 block diagram of test set up in accordance with one-way latency measurement;

FIG. 2 is a block diagram of a master or slave test instrument;

FIG. 3 is a diagram illustrating the latency measurement for determining offset between the master and slave clocks;

FIG. 4 is a graphic representation of the calculation of the latency; and

FIG. 5 is a diagram illustrating determination of offset of Master/Slave clock at the time of measurement.

### DETAILED DESCRIPTION

The system according to a preferred embodiment of the present invention comprises a system, method and test instrument adapted to determine directional latency in a computer network using native time bases of test devices, without requirement of external time base.

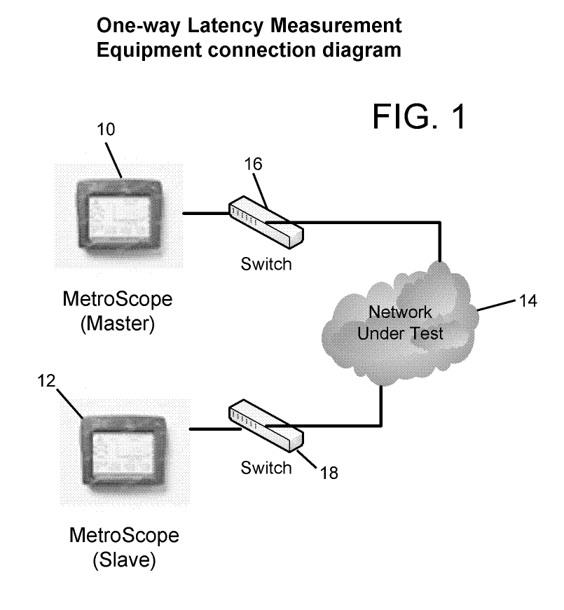

Referring to FIG. 1, a block diagram of test set up in accordance with directionally differentiated (one-way) latency measurement, in accordance with a preferred embodiment, a master test instrument 10 and slave test instrument 12 are connected to a network under test 14, suitably via switches 16, 18. In the illustrated embodiment, network under test 14 is an Ethernet. Master test instrument 10 and slave test instrument 12 each have their own clocks and are adapted to transmit and receive traffic over the network. The test instruments include processors to operate the instruments to provide network test capability. Suitable test instruments are Fluke MetroScope brand test instruments, by Fluke Corporation, Everett, Wash.

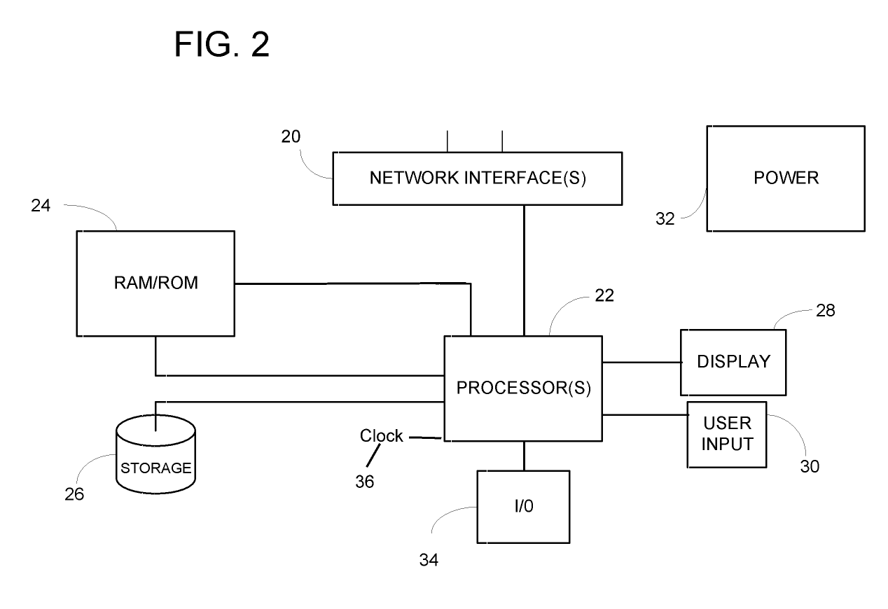

FIG. 2 is an exemplary block diagram of a test instrument 10 or 12 via which the invention can be implemented, wherein the instrument may include network interfaces 20 which attach the device to the network 14 via multiple ports, one or more processors 22 for operating the instrument, memory such as RAM/ROM 24 or persistent storage 26, display 28, user input devices 30 (such as, for example, keyboard, mouse or other pointing devices, touch screen, etc.), power supply 32 which may include battery or AC power supplies, other interface 34 which attaches the device to a network or other external devices (storage, other computer, etc.). Clock 36 provides a time base for the instrument, and suitably comprises a crystal oscillator. At least one of processors 22 may be an FPGA that is configured to timestamp packet transmit and receive times.

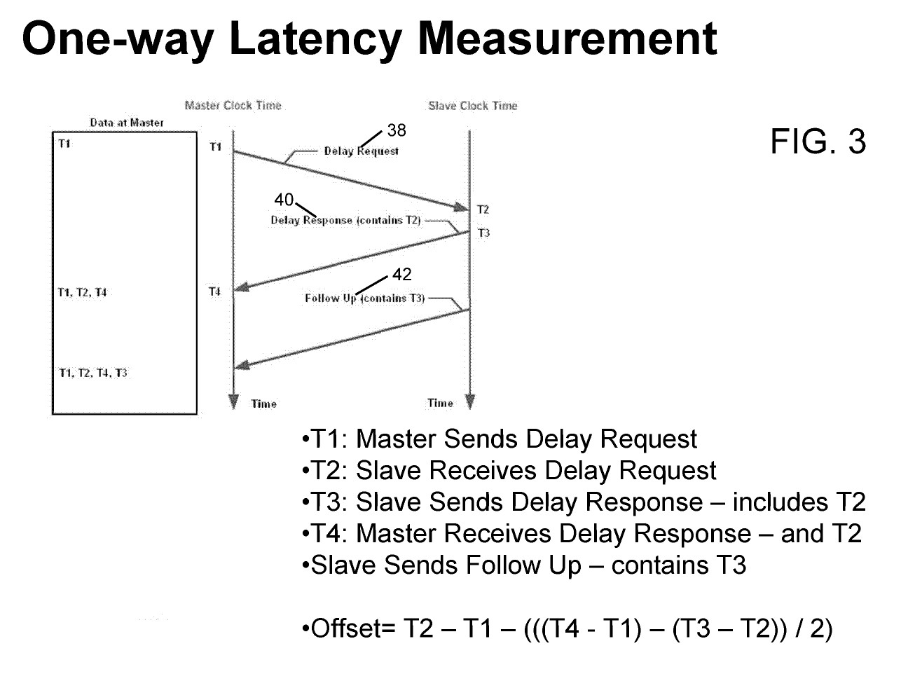

FIG. 3 is a diagram illustrating the measurement to determine offset between the master test instrument clock and slave test instrument clock for use in determining one-way latency. At time T1, the master test instrument sends a delay request 38, which is received at the slave test instrument 12 at time T2. The slave test instrument then sends a delay response 40 at time T3, the delay response including the value of T2. At time T4 the master test instrument receives the delay response (and T2). The slave test instrument next sends a follow up 42 which contains the value of T3.

Master test instrument 10 now determines the offset of the two clocks in the master and slave test instruments as follows:

Offset=T2−T1−(((T4−T1)−(T3−T2))/2)

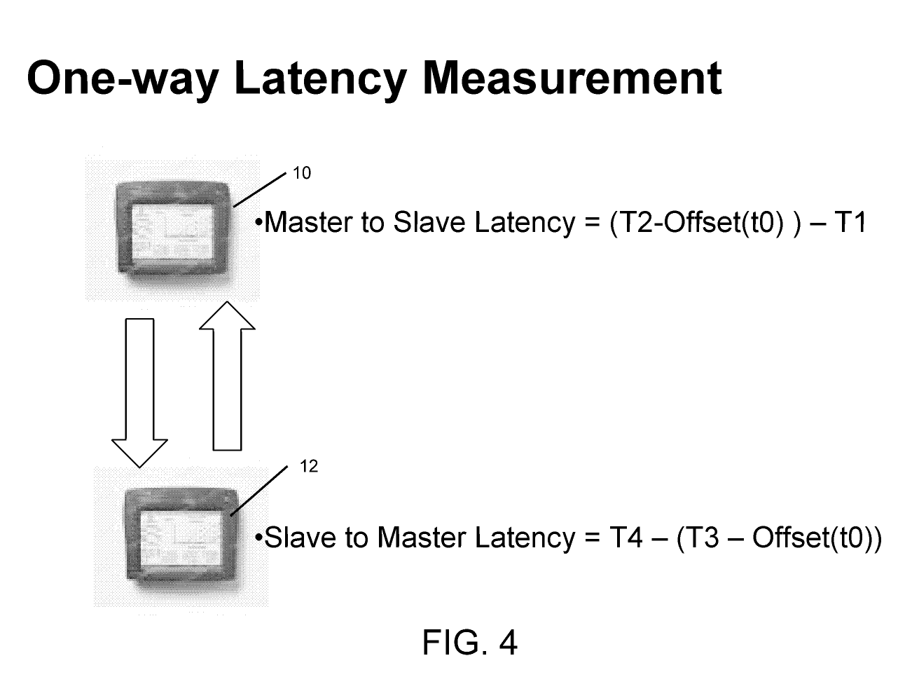

The offset value is employable to determine the master to slave latency and slave to master latency, as illustrated in FIG. 4, a graphic representation of the calculation of the latency, where the latency from master 10 to slave 12 is computed as:

Master to Slave Latency=(T2−Offset(t0))−T1

and, where the latency from slave 12 to master 10 is computed as:

Slave to Master Latency=(T4−(T3−Offset(t0))

where t0 is the time at which the latency measurement is made.

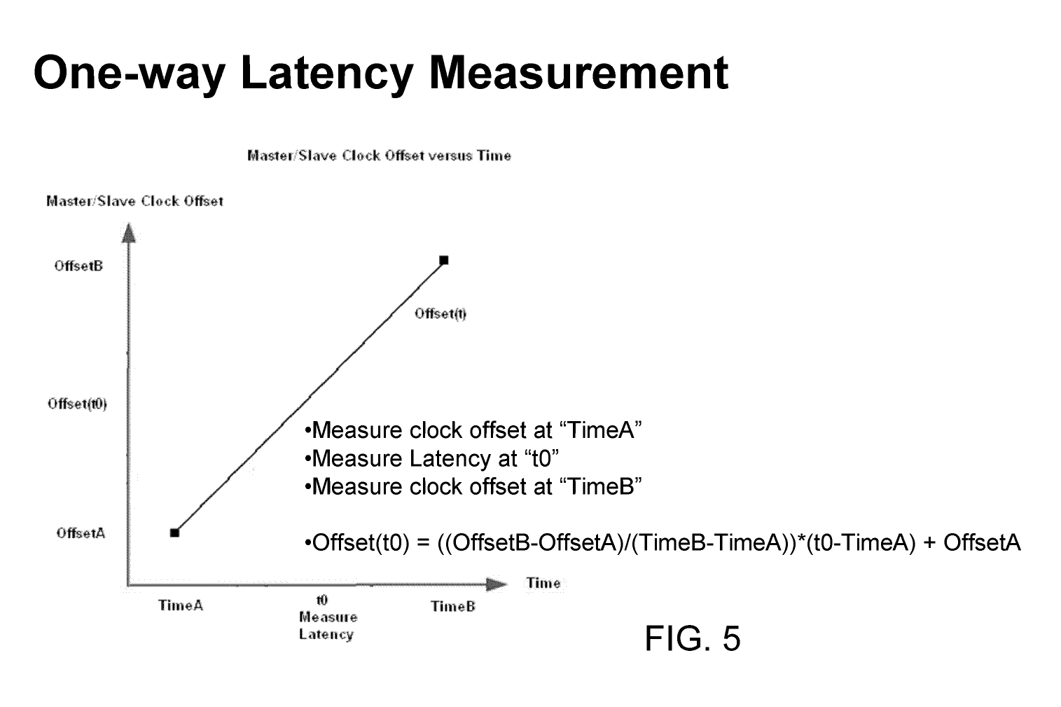

Determination of Offset(t0) is made by interpolation from the master to slave clock offset values as measured before t0 and after t0, as illustrated in FIG. 5, a diagram of Master/Slave clock offset versus time.

Referring to FIG. 5, to determine the offset at time t0, offset is measured at time TimeA, before the latency measurement time t0 and again after t0, at time TimeB. The offset at time t0 (Offset(t0)) is then determined as follows:

Offset(t0)=((OffsetB−OffsetA)/TimeB−TimeA))*(t0−TimeA)+OffsetA

where OffsetA is the offset at time TimeA and OffsetB, is the offset at time TimeB.

OffsetA and OffsetB are suitably measured without load on the network under test, with the assumption that there is symmetry of the network path, while the latency measurement at time t0 is suitably made under load, with traffic shaping, tagging, etc., and no symmetry being assumed, utilizing any network path or traffic shaping prioritization which might introduce asymmetrical latency.

Clock syncs (determination of OffsetA and OffsetB) are typically performed before and after each latency measurement, with interpolation (linear interpolation in the illustrated embodiment) of clock offset at measurement point.

While the clocks in master test instrument 10 and slave test instrument 12 will speed up and slow down over time as a factor of temperature change, such changes will occur very slowly, in time periods of minutes. The latency and time offset measurements in the illustrated embodiment, however, are made in time periods of seconds, e.g., from 1 second or less to 30 seconds, enabling a linear interpolation of the offset at time t0 to be employed and provide accurate results.

In accordance with the system, device and method herein, the master and slave test instruments record latency measurements in their native time bases, and the master (in the illustrated embodiment) retrieves the slave test instrument latency frame transmit/receive timestamps and converts them to the master's time base by use of the offset calculation noted above. The system, device and method utilize efficient 3 bounce timestamp exchange, and provide one-way latency measurement resolution of less than 100 μs, using internal clocks in the test instruments, without requirement of expensive external time base technology.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method for measuring directionally differentiated network latency, comprising:
measuring clock offset between a master clock and a slave clock at a first time TimeA;
measuring latency timing component values at a second time t0;
measuring clock offset between the master clock and the slave clock at a third time TimeB;
determining time offset between the master clock and the slave clock at time t0 using the measured clock offsets at TimeA and TimeB; and
determining directionally differentiated network latency based on latency timing component values and the determined time offset at time t0.

2. The method according to claim 1, wherein said measuring clock offset between a master clock and a slave clock comprises:
sending a delay request from the master at time T1;
sending a delay response from the slave to the master at time T3, including sending the value of time T2 when the delay request from the master was received at the slave;
sending the value of time T3 from the slave to the master;
determining the offset based on the values of T1, T2, T3 and time T4 that the master received the delay response from the slave.

3. The method according to claim 2, wherein the determining the offset based on the values of T1, T2, T3 and T4 is performed by computing the value offset=T2−T1−(((T4−T1)−(T3−T2))/2).

4. The method according to claim 3, wherein TimeB is later than time t0 and time t0 is later than TimeA, and the determined time offset at time t0 is determined by interpolating based on the offset values at TimeA and TimeB.

5. The method according to claim 4, wherein said interpolating is a linear interpolation.

6. The method according to claim 1, wherein TimeB is later than time t0 and time t0 is later than TimeA, and the determined time offset at time t0 is determined by interpolating based on the offset values at TimeA and TimeB.

7. The method according to claim 6, wherein said interpolating is a linear interpolation.

8. The method according to claim 2, wherein TimeB is later than time t0 and time t0 is later than TimeA, and the determined time offset at time t0 is determined by interpolating based on the offset values at TimeA and TimeB.

9. The method according to claim 8, wherein said interpolating is a linear interpolation.

10. The method according to claim 1, wherein said measuring clock offset between a master clock and a slave clock at a first time TimeA and said measuring clock offset between the master clock and the slave clock at a third time TimeB are performed without load on the network.

11. The method according to claim 1, wherein said measuring latency timing component values at a second time t0 is performed with load on the network.

12. The method according to claim 11, wherein said measuring latency timing component values at a second time t0 is performed utilizing network path or traffic shaping prioritization.

13. A system for measuring directionally differentiated network latency, comprising:
a master test instrument having packet transmit and receive modules for sending and receiving packets on a network and a time stamp module for recording transmit and receive times for packets;
a slave test instrument having packet transmit and receive modules for sending and receiving packets on the network and a time stamp module for recording transmit and receive times for packets; and
a processor for employing recorded transmit and receive time data to determine network latency.

14. The system according to claim 13, wherein said processor is adapted to:
determine clock offset between a master clock and a slave clock at a first time TimeA;
determine latency timing component values at a second time t0;
determine clock offset between the master clock and the slave clock at a third time TimeB;
determine time offset between the master clock and the slave clock at time t0 using the measured clock offsets at TimeA and TimeB; and
determine directionally differentiated network latency based on latency timing component values and the determined time offset at time t0.

15. A method for measuring directionally differentiated network latency between a master and a slave test instrument on an Ethernet, comprising:
measuring clock offset between a master test instrument clock and a slave instrument clock at a first time TimeA;
measuring latency timing component values at a second time t0;
measuring clock offset between the master clock and the slave clock at a third time TimeB;
determining time offset between the master clock and the slave clock at time t0 using the measured clock offsets at TimeA and TimeB; and
determining directionally differentiated network latency based on latency timing component values and the determined time offset at time t0,
wherein said measuring clock offset between a master clock and a slave clock comprises:
sending a delay request from the master at time T1;
sending a delay response from the slave to the master at time T3, including sending the value of time T2 when the delay request from the master was received at the slave;
sending the value of time T3 from the slave to the master;
determining the offset based on the values of T1, T2, T3 and time T4 that the master received the delay response from the slave; and
wherein the determining the offset based on the values of T1, T2, T3 and T4 is performed by computing the value
offset=T2−T1−(((T4−T1)−(T3−T2))/2); and
wherein TimeB is later than time t0 and time t0 is later than TimeA, and the determined time offset at time t0 is determined by interpolating based on a linear interpolation of an offset value at time t0 relative the offset values at TimeA and TimeB.
